(19) United States
(12) Patent Application Publication
(10) Pub. No.: US 2007/0214242 A1
(43) Pub. Date: Sep. 13, 2007

(54) Network configuration change evaluation program, network configuration change evaluation device, and network configuration change evaluation method

(75) Inventors: Yukihiro Watanabe, Kawasaki (JP); Keiichi Oguro, Kawasaki (JP); Kuniaki Shimada, Kawasaki (JP); Ken Yokoyama, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/494,967

(22) Filed: Jul. 28, 2006

(30) Foreign Application Priority Data
Mar. 13, 2006 (JP) 2006-067014

(51) Int. Cl. G06F 15/177

(52) U.S. Cl. 709/220

(57) ABSTRACT

The present invention provides a network configuration change evaluation program, a network configuration change evaluation device, and a network configuration change evaluation method which can evaluate influence due to configuration change of a network. There is provided a network configuration change evaluation program that makes a computer execute the evaluation of influence due to configuration change of a network, the program making a computer execute a configuration change information acquisition step that acquires topology information indicating the topology of a network before the configuration change and device setting change information that is information on setting change of devices in the network, and an influence range extraction step that extracts influence service information or information on services to be influenced by the configuration change based on the topology information and the device setting change information which are acquired by the configuration change information acquisition step.

### BACKGROUND OF THE INVENTION

1. Field of the Invention

The present invention relates to a network configuration change evaluation program, a network configuration change evaluation device, and a network configuration change evaluation method which are adapted to manage the configuration of a network.

2. Description of the Related Art

In operating and managing a network that is being enlarged in scale, it is becoming important to comprehend and manage physical link configuration and logical link configuration (topology) among devices configuring the network. Conventionally, the manager changes the topology of a network in the following manner.

S101. Design a network configuration after change.

S102. Verify a network configuration after change on the desk.

S103. Perform configuration change work.

S104. Confirm operation after configuration change.

Concerning steps S102, S104, it is necessary to verify the configuration after change, paying attention to the following notice points.

Notice point 1. Functions and performances being objects of change are realized.

Notice point 2. Functions other than the objects of change are operated without trouble.

As a conventional technique related to the present invention, there is known a technique that searches for the topology of network devices (for example, Patent Document 1: Jpn. Pat. Appln. Laid-Open Publication No. 2005-348051). According to this technique, a topology search unit searches for the topology for each layer based on physical link information and setting information of respective devices, and outputs topologies of a plurality of layers.

However, of above-described notice points, even if the notice point 1 can be confirmed easily, it is difficult to confirm the notice point 2 since the number of combinations of functions that have to be confirmed is significantly large.

This is because the manager does not know which devices the respective functions (application service, TCP (Transmission Control Protocol) load sharing, routing, switching, etc.) provided by a network use.

Accordingly, in the processing S102, information necessary for verification comes to be insufficient, and only evaluation restricted to a single function (routing etc.) could be performed. Furthermore, there exists a means that notifies the manager of changes in the topology of a network such as port opening/closing, link establishment, disconnection, etc. by making network devices monitor themselves, while it has been impossible to evaluate influence of configuration change exerted on functions of an existing network.

### SUMMARY OF THE INVENTION

It is therefore an object of the present invention to overcome the above-mentioned drawbacks by providing a network configuration change evaluation program, a network configuration change evaluation device, and a network configuration change evaluation method which can evaluate influence due to configuration change of a network.

To solve the problems, the present invention provides a network configuration change evaluation program that makes a computer execute the evaluation of influence due to configuration change of a network, the program making a computer execute the steps including a configuration change information acquisition step that acquires topology information indicating the topology of a network before the configuration change and device setting change information that is information of setting change of devices in the network, and an influence range extraction step that extracts information on services to be influenced by the configuration change based on the topology information and the device setting change information which are acquired by the configuration change information acquisition step.

According to the network configuration change evaluation program, the influence range extraction step further extracts information on devices to be influenced by the configuration change based on the information on services to be influenced by the configuration change.

According to the network configuration change evaluation program, the configuration change information acquisition step receives messages from devices in the network, and, of the messages, converts messages indicative of the contents of setting change of devices to the device setting change information.

According to the network configuration change evaluation program, the topology information includes device link information that is information on link of devices and device setting information that is information on setting of devices for respective layers in a network before the configuration change.

According to the network configuration change evaluation program, the influence range extraction step extracts the information on services to be influenced by the configuration change by extracting devices and layers corresponding to the device setting change information from the device setting information and extracting services using thus extracted devices and layers from the device link information.

According to the network configuration change evaluation program, the influence range extraction step extracts devices and layers corresponding to the device setting change information from the device setting information by determining that the change of topology of a lower layer has an influence on the topology of an upper layer in the device setting change information.

The present invention also provides a network configuration change evaluation device that performs the evaluation of influence due to configuration change of a network, the device including a configuration change information acquisition unit that acquires topology information indicating the topology of a network before the configuration change and device setting change information that is information on setting change of devices in the network, and an influence range extraction unit that extracts information on services to be influenced by the configuration change based on the topology information and the device setting change information which are acquired by the configuration change information acquisition unit.

According to the network configuration change evaluation device, the influence range extraction unit further extracts information on devices to be influenced by the configuration change based on the information on services to be influenced by the configuration change.

According to the network configuration change evaluation device, the configuration change information acquisition unit receives messages from devices in the network, and, of the messages, converts messages indicative of the contents of setting change of devices to the device setting change information.

According to the network configuration change evaluation device, the topology information includes device link information that is information on link of devices and device setting information that is information on setting of devices for respective layers in a network before the configuration change.

According to the network configuration change evaluation device, the influence range extraction unit extracts the information on services to be influenced by the configuration change by extracting devices and layers corresponding to the device setting change information from the device setting information and extracting services using thus extracted devices and layers from the device link information.

According to the network configuration change evaluation device, the influence range extraction unit extracts devices and layers corresponding to the device setting change information from the device setting information by determining that the change of topology of a lower layer has an influence on the topology of an upper layer in the device setting change information.

The present invention also provides a network configuration change evaluation method that performs the evaluation of influence due to configuration change of a network, the method including a configuration change information acquisition step that acquires topology information indicating the topology of a network before the configuration change and device setting change information that is information on setting change of devices in the network, and an influence range extraction step that extracts information on services to be influenced by the configuration change based on the topology information and the device setting change information which are acquired by the configuration change information acquisition step.

According to the present invention, it becomes possible to evaluate influence due to configuration change of a network in advance.

### BRIEF DESCRIPTION OF THE DRAWINGS

FIG. 1 shows a block diagram of one example of the configuration of the network configuration change evaluation device according to the first embodiment;

FIG. 2 shows a block diagram of one example of a topology model according to the present invention;

FIG. 3 shows a block diagram of one example of a specific topology model according to the first embodiment;

FIG. 4 shows a diagram of one example of the configuration of topology information 503 according to the first embodiment;

FIG. 5 shows a diagram of one example of device link information 701 according to the first embodiment;

FIG. 6 shows a diagram of one example of device setting information 702 according to the first embodiment;

FIG. 7 shows a diagram of one example of device setting change information 504 according to the first embodiment;

FIG. 8 shows a diagram of one example of the configuration of a configuration change interpretation unit 501 according to the first embodiment;

FIG. 9 shows a flowchart of one example of the operation of a configuration change classification unit 1202 according to the first embodiment;

FIG. 10 shows a diagram of one example of configuration change information 505 according to the first embodiment;

FIG. 11 shows a diagram of one example of the configuration of an influence range extraction unit 502 according to the first embodiment;

FIG. 12 shows a flowchart of one example of the operation of an influence link extraction unit 1501 according to the first embodiment;

FIG. 13 shows a diagram of one example of influence service information 506 according to the first embodiment;

FIG. 14 shows a flowchart of one example of the operation of an intra-influence-range device extraction unit 1502 according to the first embodiment;

FIG. 15 shows a diagram of one example of influence device information 507 according to the first embodiment;

FIG. 16 shows a block diagram of another example of a specific topology model according to the first embodiment; and

FIG. 17 shows a block diagram of one example of the configuration of the network configuration change evaluation device according to the second embodiment.

### DETAILED DESCRIPTION OF THE PREFERRED EMBODIMENTS

The embodiments of the present invention will further be described below with reference to the accompanying drawings.

### First Embodiment

In the first embodiment, a network configuration change evaluation device that generates information on services and devices which are to be influenced by configuration change based on topology information of a current network and setting change information of respective devices will be explained.

Firstly, the configuration of the network configuration change evaluation device according to the present embodiment will be explained.

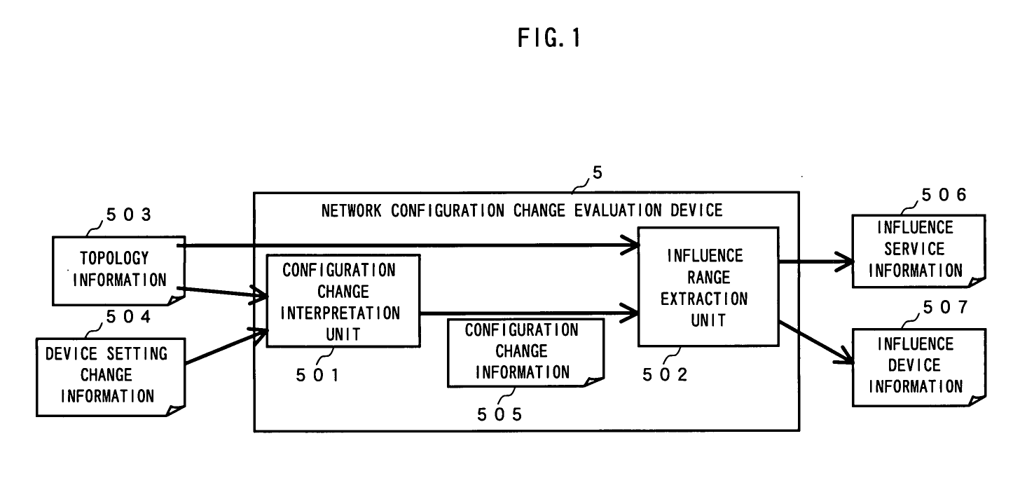

FIG. 1 shows a block diagram of one example of the configuration of a network configuration change evaluation device 5 according to the first embodiment. The network configuration change evaluation device 5 includes a configuration change interpretation unit 501 and an influence range extraction unit 502.

The configuration change interpretation unit 501 generates configuration change information 505 using topology information 503 indicating the topology of a current network and device setting change information 504 indicating the contents of setting change of respective devices. The influence range extraction unit 502 generates, using the configuration change information 505, influence service information 506 being information on services to be influenced by configuration change and influence device information 507 being information on devices to be influenced by configuration change.

Next, a topology model that is used by the network configuration change evaluation device 5 so as to extract influence of setting change will be explained.

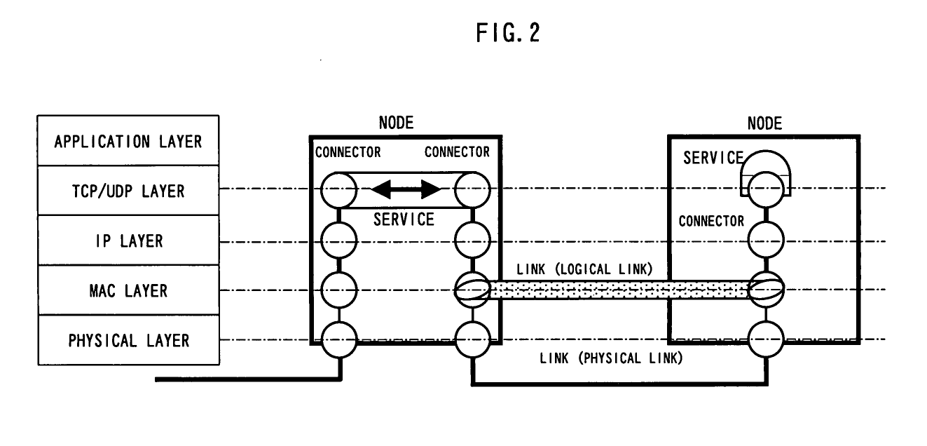

FIG. 2 shows a block diagram of one example of a topology model according to the present invention. This topology model is based on the technique of the Patent document 1, and indicates links of respective layers among devices (nodes) on a network. As layers, for example, there are a physical layer, a MAC (Media Access Control) layer, an IP (Internet Protocol) layer, a TCP (Transmission Control Protocol)/UDP (User Datagram Protocol) layer, and an application layer. Furthermore, in respective layers, this topology model represents the topology using three simple elements, that is, a “link” being a link between devices, a “connector” being a physical interface or a logical interface of a device used for the link, and a “service” being data transmission and reception among a plurality of connectors in a device.

The link in an upper layer is configured by the link in a lower layer and the service in a device. Accordingly, the change of topology of a lower layer has an influence on the topology of an upper layer, while the change of topology of an upper layer does not have an influence on the topology of a lower layer. Based on the rule, an influence range of configuration change in the topology model is retrieved.

Next, a specific topology model of a network that is employed by the network configuration change evaluation device according to the first embodiment will be explained.

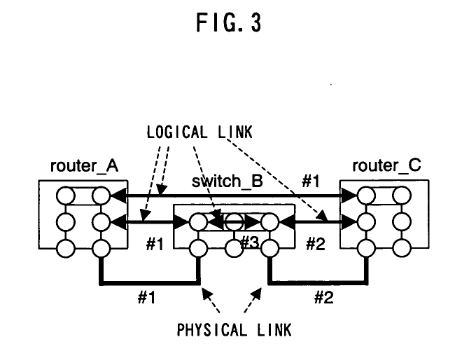

FIG. 3 shows a block diagram of one example of a specific topology model according to the first embodiment. The topology model shown in FIG. 3 has, as nodes, a router A and a router C which perform packet filtering in the IP layer, and a switch B which performs packet transfer in the MAC layer. The router A and the router C are linked through the switch B. In the physical layer, there are a link (#1) between the router A and the switch B, and a link (#2) between the switch B and the router C. In the MAC layer, there are a link (#1) between the router A and the switch B, a link (#2) between the switch B and the router C, and a link (#3) between connectors of the switch B. In the IP layer, there is a link (#1) between the router A and the router C.

Next, the topology information 503 will be explained.

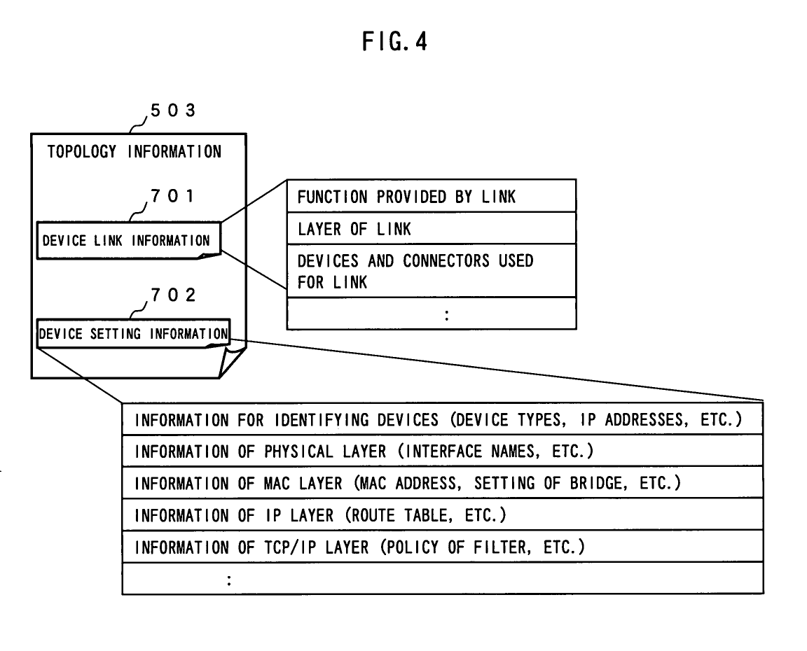

FIG. 4 shows a diagram of one example of the configuration of the topology information 503 according to the first embodiment. The topology information 503 includes device link information 701 and device setting information 702. The device link information 701 includes information on functions provided by the link, information on layer of the link, information on devices and connectors used for the link, etc. The device setting information 702 includes information for identifying devices (device types, IP addresses, etc.), information on the physical layer (interface names, etc.), information on the MAC layer (MAC address, setting of bridge, etc.), information on the IP layer (route table, etc.), information on a TCP/IP layer (policy of filter, etc.), etc. The device link information 701 and device setting information 702 are described by the XML (extensible Markup Language).

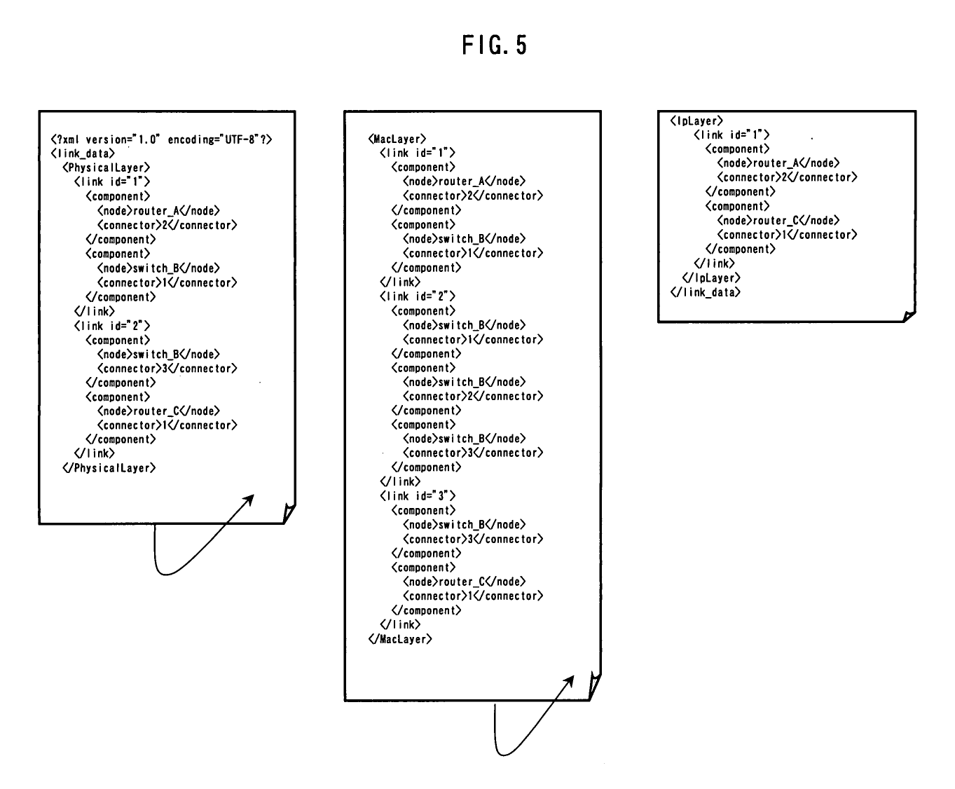

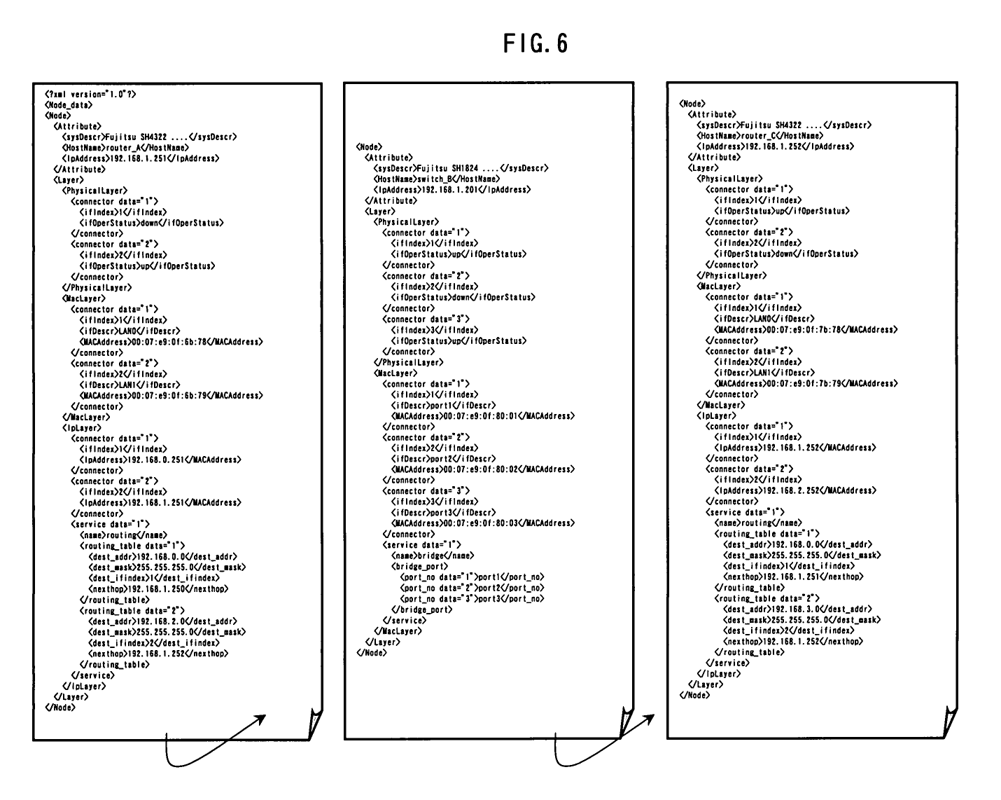

FIG. 5 shows a diagram of one example of the device link information 701 according to the first embodiment. The device link information 701 in FIG. 5 includes the link information in the physical layer (<PhysicalLayer>), link information in the MAC layer (<MacLayer>), and link information in the IP layer (<IpLayer>). FIG. 6 shows a diagram of one example of the device setting information 702 according to the embodiment. In the device setting information 702, the setting of the router A, setting of the switch B, and setting of the router C are described respectively.

Next, the device setting change information 504 will be explained.

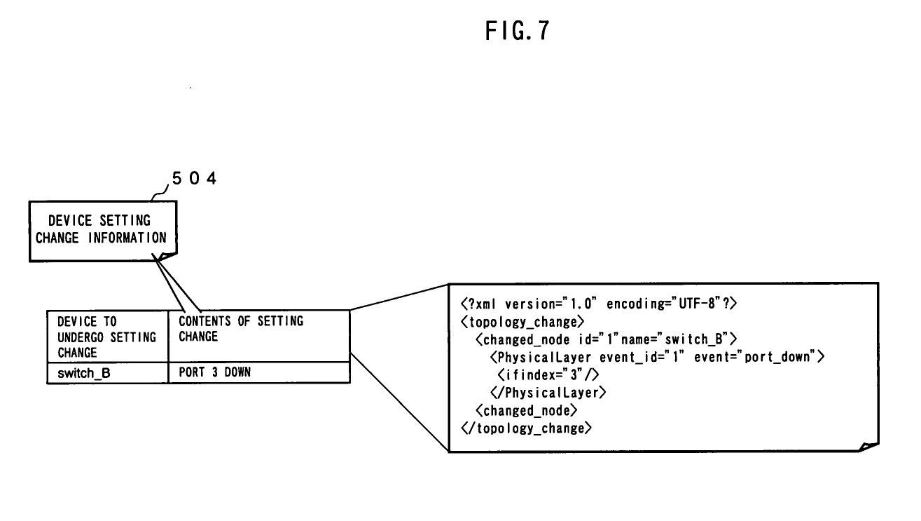

FIG. 7 shows a diagram of one example of the device setting change information 504 according to the first embodiment. The device setting change information 504 is also described by the XML. The device setting change information 504 includes an identifier of a device which is to undergo setting change and contents of the setting change. In FIG. 7, the device setting change information 504 indicates that, as setting change, port 3 down has been carried out in the switch B.

Next, the configuration change interpretation unit 501 will be explained.

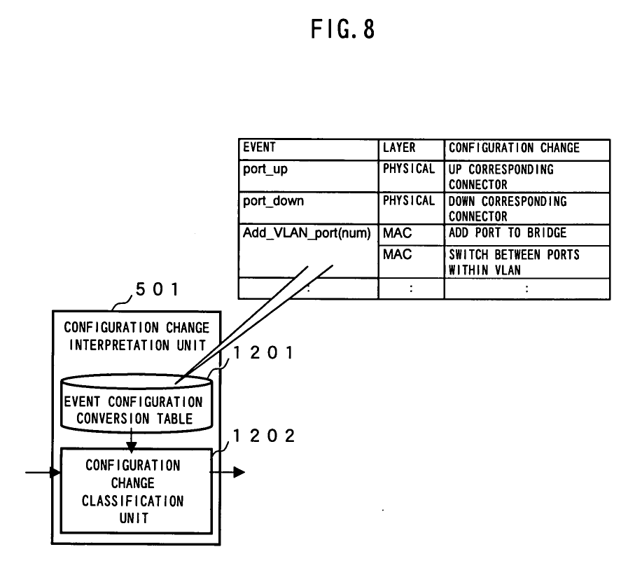

FIG. 8 shows a diagram of one example of the configuration of the configuration change interpretation unit 501 according to the first embodiment. The configuration change interpretation unit 501 includes an event configuration conversion table 1201 and a configuration change classification unit 1202. The event configuration conversion table 1201 associates events of configuration change with changes exerted on the topology in a device caused by the configuration change, and includes items of events (events to be described in the device setting change information 504), layers corresponding to the events, configuration change contents for respective layers. The configuration change classification unit 1202 receives the device setting change information 504 and device setting information 702, and outputs the configuration change information 505 indicative of the change of topology in a device using the event configuration conversion table 1201.

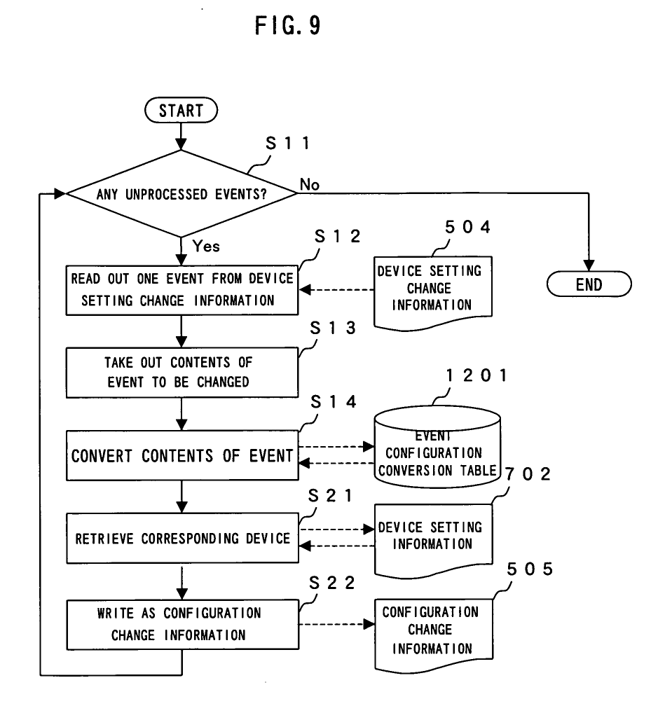

FIG. 9 shows a flowchart of one example of the operation of the configuration change classification unit 1202 according to the first embodiment. Firstly, the configuration change classification unit 1202 judges whether or not there are unprocessed events in the device setting change information 504 (S11). In case all events are processed (S11, N), this flow is ended. On the other hand, in case there are unprocessed events (S11, Y), the configuration change classification unit 1202 reads out one event from the device setting change information 504 (S12), and takes out contents of the event to be changed (S13). Next, the configuration change classification unit 1202 converts contents of the event into corresponding configuration change contents using the event configuration conversion table 1201 (S14), and retrieves a device and a layer corresponding to the configuration change contents using the device setting information 702 (S21). In this embodiment, a device and a layer corresponding to the configuration change contents are retrieved based on the rule of above-described topology model. Next, the configuration change classification unit 1202 writes the configuration change of thus retrieved device and layer as the configuration change information 505 (S22), returning to step S11.

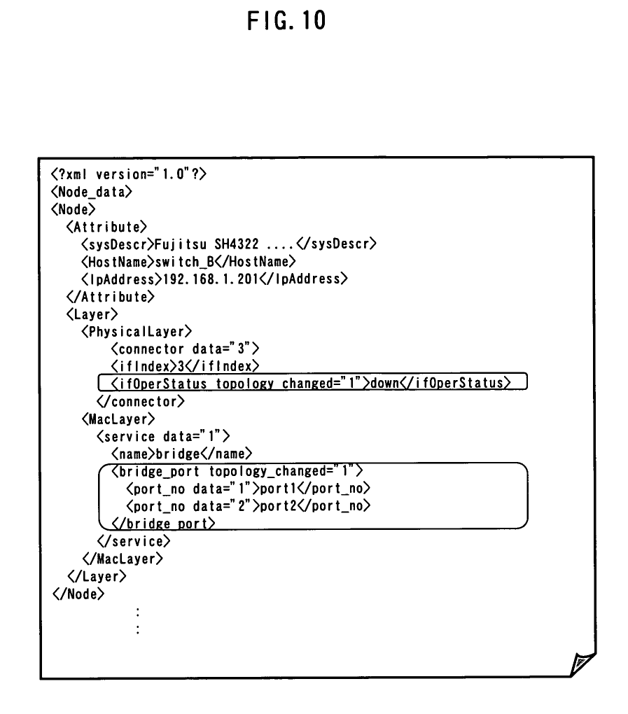

FIG. 10 shows a diagram of one example of the configuration change information 505 according to the first embodiment. The configuration change information 505 is also described by the XML. In FIG. 10, the configuration change information 505 corresponds to above-described device setting change information 504, and represents the change of the physical layer of the switch B and also the resultant change of the MAC layer.

Next, the influence range extraction unit 502 will be explained.

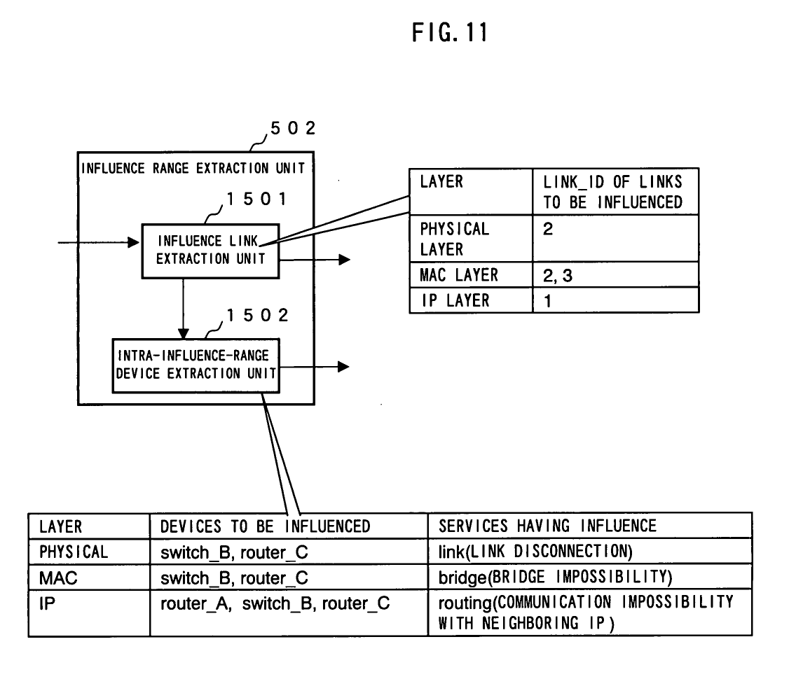

FIG. 11 shows a diagram of one example of the configuration of the influence range extraction unit 502 according to the first embodiment. The influence range extraction unit 502 includes an influence link extraction unit 1501 and an intra-influence-range device extraction unit 1502. The influence link extraction unit 1501 stores link identifiers (link_id) of links to be influenced for respective layers. The intra-influence-range device extraction unit 1502 stores identifiers of devices to be influenced as well as identifiers of services having an influence, for respective layers.

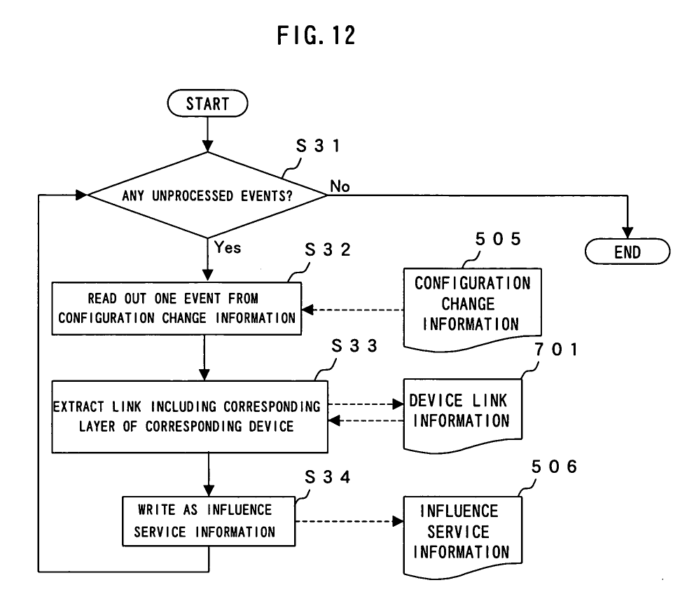

FIG. 12 shows a flowchart of one example of the operation of the influence link extraction unit 1501 according to the first embodiment. Firstly, the influence link extraction unit 1501 judges whether or not there are unprocessed events in the configuration change information 505 (S31). In case all events are processed (S31, N), this flow is ended. On the other hand, in case there are unprocessed events (S31, Y), the influence link extraction unit 1501 reads out one event from the configuration change information 505 (S32), extracts a link including a corresponding layer of a device corresponding to the event from the device link information 701 (S33), and writes the link as the influence service information 506 (S34), returning to step S31.

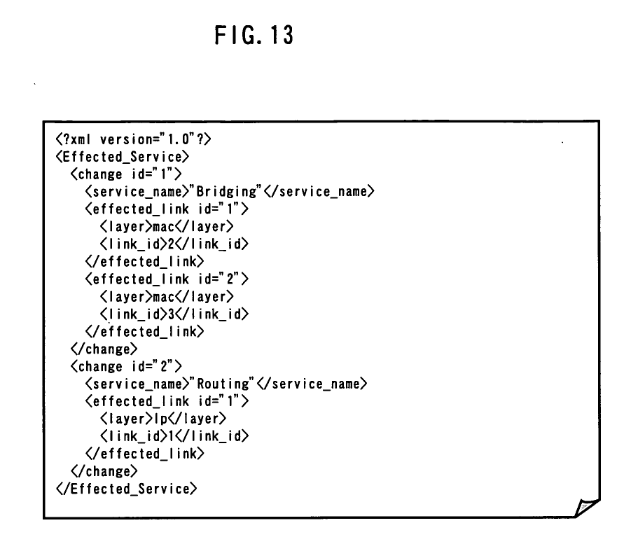

FIG. 13 shows a diagram of one example of the influence service information 506 according to the first embodiment. The influence service information 506 is also described by the XML. In the influence service information 506, a layer and a link identifier are described for respective services to be influenced by configuration change.

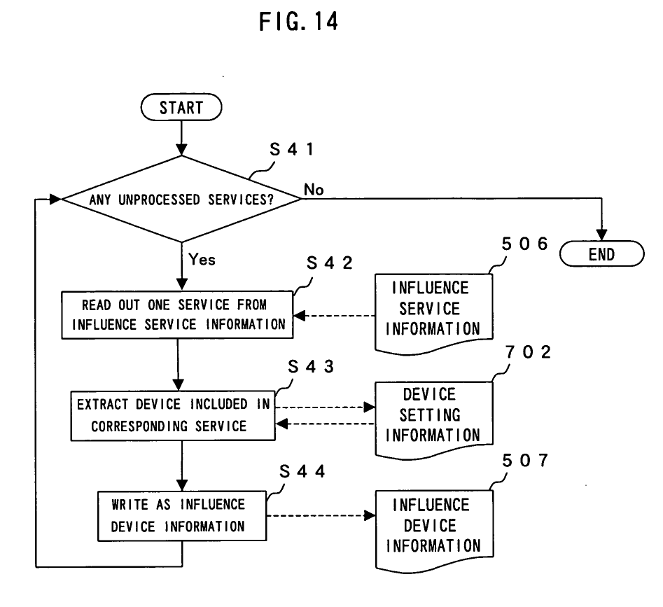

FIG. 14 shows a flowchart of one example of the operation of the intra-influence-range device extraction unit 1502 according to the first embodiment. Firstly, the intra-influence-range device extraction unit 1502 judges whether or not there are unprocessed services in the influence service information 506 (S41). In case all services are processed (S41, N), this flow is ended. On the other hand, in case there are unprocessed services (S41, Y), the intra-influence-range device extraction unit 1502 reads out one service from the influence service information 506 (S42), extracts a device included in a corresponding service from the device setting information 702 (S43), and writes the device as the influence device information 507 (S44), returning to step S41.

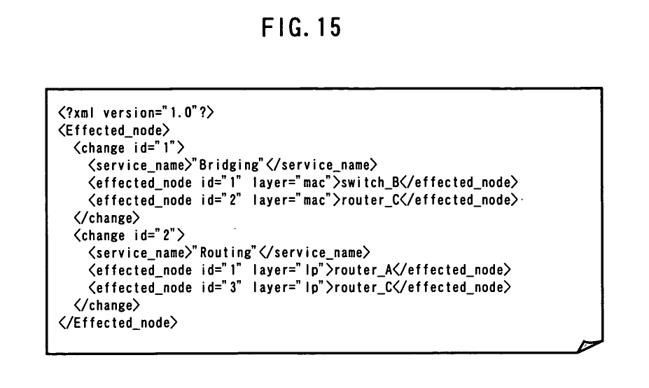

FIG. 15 shows a diagram of one example of the influence device information 507 according to the first embodiment. The influence device information 507 is also described by the XML. In the influence device information 507, a layer and a device identifier to be influenced by configuration change are described for respective services to be influenced by configuration change.

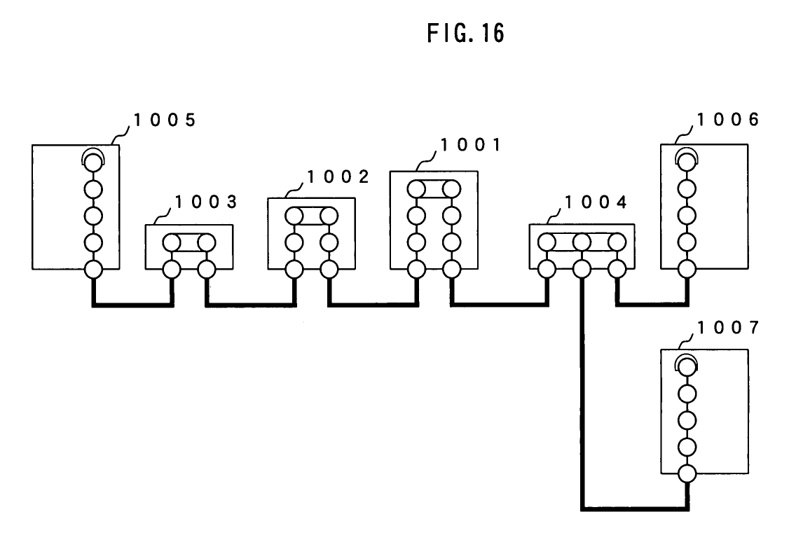

In the embodiment, the present invention is applied to a network device using a physical layer, a MAC layer, and an IP layer. Furthermore, the present invention may be applied to a network device using upper layers of a TCP/UDP layer, an application layer, etc. FIG. 16 shows a block diagram of another example of a specific topology model according to the first embodiment. A network in the topology model in FIG. 16 includes a firewall device 1001 that performs packet filtering in the TCP/UDP layer (fourth layer), a router device 1002 that performs packet transfer in the IP layer (third layer), switch devices 1003, 1004 that perform packet transfer in the MAC layer (second layer), a PC (personal computer) device 1005 that is a terminal utilizing a network service (fifth layer), and Web devices 1006, 1007 which are terminals providing Web services in the application layer (fifth layer).

According to the present embodiment, influence due to configuration change of a network can be evaluated in advance. Accordingly, a trouble after the configuration change can be prevented.

### Second Embodiment

In the second embodiment, a network configuration change evaluation device that generates information of services and devices which are to be influenced by configuration change based on the topology information of a current network and the setting change notification from devices will be explained.

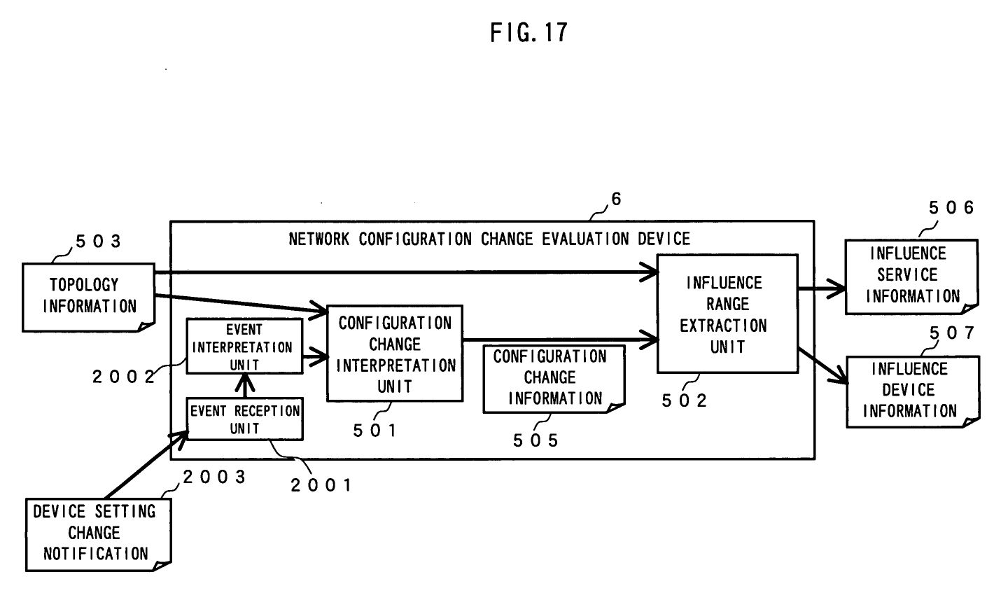

FIG. 17 shows a block diagram of one example of the configuration of a network configuration change evaluation device 6 according to the second embodiment. In FIG. 17, parts or components similar to those shown in FIG. 1 are indicated with the same reference numerals, and detailed explanation of which will be omitted. As compared with the network configuration change evaluation device 5 shown in FIG. 1, the network configuration change evaluation device 6 shown in FIG. 17 further includes an event reception unit 2001, and an event interpretation unit 2002.

The event reception unit 2001 monitors messages such as SNMP (Simple Network Management Protocol) from respective devices, and sends the messages to the event interpretation unit 2002. The event interpretation unit 2002 has a conversion table in which association between messages from devices and contents of configuration change is described in advance, and, of messages received by the event reception unit 2001, converts device setting change notification 2003 indicative of the contents of setting change of devices to the form of the device setting change information 504 using the conversion table, and sends thus converted notification to the configuration change interpretation unit 501. Following operations of the respective units are similar to those in the first embodiment. On the other hand, there may be employed a configuration in which following operations are carried out at the time the event interpretation unit 2002 forms the device setting change information 504 so that the network configuration change evaluation device 6 automatically evaluates influence when setting change of a device is brought about.

According to the second embodiment, an influence range to a network when configuration change is brought about can be evaluated in detail. Accordingly, judgment whether or not configuration change is considered to be a failure as well as specification of service to be influenced in case the configuration change is determined to be a failure become easy.

The network configuration change evaluation device according to the second embodiment can be easily applied to information processing devices, improving the performance of the information processing devices. The information processing devices may be a server for a manager, a personal computer, etc.

Furthermore, a program that makes a computer, which configures the network configuration change evaluation device, execute above-described respective steps can be provided as a network configuration change evaluation program. The respective steps can be executed by a computer that configures the network configuration change evaluation device by making a computer-readable recording medium store the program. In the embodiment, the computer-readable recording medium may be an internal storage device such as a ROM, RAM, which are mounted inside a computer, or a portable recording medium such as a CD-ROM, flexible disk, DVD disk, magnet-optical disk, IC card, or a database storing computer programs, or other computers and their databases, or a transmission medium on a line.

The configuration change information acquisition step corresponds to the processing of the configuration change interpretation unit in the embodiment. Furthermore, the configuration change information acquisition unit corresponds to the configuration change interpretation unit in the embodiment.

What is claimed is:

1. A network configuration change evaluation program that makes a computer execute the evaluation of influence due to configuration change of a network, the program making a computer execute:
a configuration change information acquisition step that acquires topology information indicating the topology of a network before the configuration change and device setting change information that is information on setting change of devices in the network; and
an influence range extraction step that extracts information on services to be influenced by the configuration change based on the topology information and the device setting change information which are acquired by the configuration change information acquisition step.

2. The network configuration change evaluation program according to claim 1, wherein the influence range extraction step further extracts information on devices to be influenced by the configuration change based on the information on services to be influenced by the configuration change.

3. The network configuration change evaluation program according to claim 1, wherein the configuration change information acquisition step receives messages from devices in the network, and, of the messages, converts messages indicative of the contents of setting change of devices to the device setting change information.

4. The network configuration change evaluation program according to claim 1, wherein the topology information includes device link information that is information on link of devices and device setting information that is information on setting of devices for respective layers in a network before the configuration change.

5. The network configuration change evaluation program according to claim 4, wherein the influence range extraction step extracts the information on services to be influenced by the configuration change by extracting devices and layers corresponding to the device setting change information from the device setting information and extracting services using thus extracted devices and layers from the device link information.

6. The network configuration change evaluation program according to claim 5, wherein the influence range extraction step extracts devices and layers corresponding to the device setting change information from the device setting information by determining that the change of topology of a lower layer has an influence on the topology of an upper layer in the device setting change information.

7. A network configuration change evaluation device that performs the evaluation of influence due to configuration change of a network, comprising:
a configuration change information acquisition unit that acquires topology information indicating the topology of a network before the configuration change and device setting change information that is information on setting change of devices in the network; and
an influence range extraction unit that extracts information on services to be influenced by the configuration change based on the topology information and the device setting change information which are acquired by the configuration change information acquisition unit.

8. The network configuration change evaluation device according to claim 7, wherein the influence range extraction unit further extracts information of devices to be influenced by the configuration change based on the service information to be influenced by the configuration change.

9. The network configuration change evaluation device according to claim 7, wherein the configuration change information acquisition unit receives messages from devices in the network, and, of the messages, converts messages indicative of the contents of setting change of devices to the device setting change information.

10. The network configuration change evaluation device according to claim 7, wherein the topology information includes device link information that is information on link of devices and device setting information that is information on setting of devices for respective layers in a network before the configuration change.

11. The network configuration change evaluation device according to claim 10, wherein the influence range extraction unit extracts the information on services to be influenced by the configuration change by extracting devices and layers corresponding to the device setting change information from the device setting information and extracting services using thus extracted devices and layers from the device link information.

12. The network configuration change evaluation device according to claim 11, wherein the influence range extraction unit extracts devices and layers corresponding to the device setting change information from the device setting information by determining that the change of topology of a lower layer has an influence on the topology of an upper layer in the device setting change information.

13. A network configuration change evaluation method that performs the evaluation of influence due to configuration change of a network, comprising:
a configuration change information acquisition step that acquires topology information indicating the topology of a network before the configuration change and device setting change information that is information on setting change of devices in the network; and
an influence range extraction step that extracts information on services to be influenced by the configuration change based on the topology information and the device setting change information which are acquired by the configuration change information acquisition step.

14. The network configuration change evaluation method according to claim 13, wherein the influence range extraction step further extracts information of devices to be influenced by the configuration change based on the service information to be influenced by the configuration change.

15. The network configuration change evaluation method according to claim 13, wherein the configuration change information acquisition step receives messages from devices in the network, and, of the messages, converts messages indicative of the contents of setting change of devices to the device setting change information.

16. The network configuration change evaluation method according to claim 13, wherein the topology information includes device link information that is information on link of devices and device setting information that is information on setting of devices for respective layers in a network before the configuration change.

17. The network configuration change evaluation method according to claim 16, wherein the influence range extraction step extracts the information on services to be influenced by the configuration change by extracting devices and layers corresponding to the device setting change information from the device setting information and extracting services using thus extracted devices and layers from the device link information.

18. The network configuration change evaluation method according to claim 17, wherein the influence range extraction step extracts devices and layers corresponding to the device setting change information from the device setting information by determining that the change of topology of a lower layer has an influence on the topology of an upper layer in the device setting change information.
